(19) United States
(12) Patent Application Publication
(10) Pub. No.: US 2005/0043993 A1
(43) Pub. Date: Feb. 24, 2005

(54) Program controlled apparatus, system and method for soliciting personal information from a user over an interactive communications network and dynamically selecting and transmitting graphics based routines to the user for displaying content selected according to the information input by the user and corresponding demographic, geographic and psychographic profile

(76) Inventors: Andrew Stollman, Saddle River, NJ (US); Andrew Sturgeon, (US); Marco Potvin, Moucton (CA)

Correspondence Address: STEINBERG & RASKIN, P.C., 1140 AVENUE OF THE AMERICAS, 15th FLOOR, NEW YORK, NY, 10036-5803, US

(21) Appl. No.: 10/805,140

(22) Filed: Mar. 19, 2004

Related U.S. Application Data
(60) Provisional application No. 60/456,132, filed on Mar. 19, 2003.

(51) Int. Cl. G06F 17/60; H04K 1/00; H04L 9/00

(52) U.S. Cl. 705/14

(57) ABSTRACT

A sweepstakes entry system and method are disclosed for soliciting and capturing selected personal data from a user over an interactive communications network and, based on the personal data retrieved, dynamically selecting and transmitting selected graphics based applets to the user. The system comprises at least one server having first programming for generating solicitation data and transmitting the data to a user. A program controlled apparatus has first programming for generating solicitation data and transmitting the data to a user, second programming for determining whether the user is to receive sweepstakes winnings, and third programming for electronically depositing money corresponding to the sweepstakes winnings in a financial account of the user. Also provided with the server or, alternatively, in a second server, is programming for processing selected personal data received from the user in response to the solicitation data and transmitting discrete content data targeted to the user based on the personal data received. A first database stores the personal data input by the user pursuant to the solicitation data displayed. Finally, an interactive communications network is provided for facilitating the transfer of data between the program controlled apparatus and the server(s). At least one of the first and second servers houses a virtual portal for receiving the personal data and for transmitting the solicitation and discrete content data to the user over the interactive communications network.

This Application is based upon and claims the benefit of U.S. Provisional Application Ser. No. 60/456,132, filed Mar. 19, 2003.

### FIELD OF THE INVENTION

The present invention relates generally to interactive data transmission and reception and, more particularly, to a program controlled apparatus, system and method for soliciting selected personal information from users over an interactive communications network and dynamically transmitting graphics based applets to the users for displaying content to them based on their personal information.

### BACKGROUND OF THE INVENTION

Conventional wisdom has been that the more a business knows about its customers, and especially who they are, the more effective it can be in marketing its goods and services to them. In recent years, with the proliferation of the Internet, this maxim has risen to an entirely new level. Today, by using world-wide interactive communications networks, not only has direct dealer-to-customer contact been made possible, but also specific targeting of the customers over a wide range of products and services, to the delight of marketeers.

A new objective is to collect detailed information about the customer, the more information, the better, so that a detailed customer profile can be created. While many businesses now have relatively direct access to their customers, recent concerns with privacy and identity theft has generated wide-spread paranoia among on-line users. This paranoia has lead to a reluctance to provide personal information so critical to present day marketeers. Hence, despite the tremendous accessibility to customers that has been created by the Internet, obtaining their personal information and, more importantly, generating detailed customer profiles has become increasingly difficult.

One way to counter this problem has been to solicit personal information from customers through gaming and prize reward systems. Such systems typically offer each user, i.e., potential customer, a chance to win a prize in exchange for providing such information. While this approach has met with some success, many users remain skeptical that their personal information will be used in the manner represented and/or that there is, indeed, any chance of winning a prize. A special concern is that their information will be sold or otherwise provided to “junk mail” merchants or to marketeers who will bombard them with e-mail solicitations and other Internet SPAM. Hence, although the Internet provides businesses with the physical network and means for collecting information about their customers, practical considerations and conventional methodologies have been found relatively ineffective for consistently and reliably obtaining information from a vast majority of their customers on-line.

A system and a method are, therefore, desired that would enable a business to consistently and effectively solicit selected personal information from a user and, based upon the information obtained, allow the business to generate a user profile based on geographic, demographic and/or psychographic parameters for targeting the user for future on-line advertising or the like.

### OBJECTS AND SUMMARY OF THE INVENTION

According to one aspect of the present invention, a sweepstakes entry system is provided for soliciting and capturing selected personal information from a user over an interactive communications network and, based on the personal data retrieved, dynamically selecting and transmitting selected graphics based applets to the user, the system comprising:
a first server having first programming for generating solicitation data and transmitting the data to a user, second programming for determining whether the user is to receive sweepstakes winnings, and third programming for electronically depositing money corresponding to the sweepstakes winnings in a financial account of the user;
a first program controlled apparatus having programming for receiving the solicitation data from the first server, displaying the data to the user in a selected data format, receiving personal data input by the user, and transmitting the personal data to the second server;
a second server having programming for processing selected personal data received from the user in response to the solicitation data and transmitting discrete content data targeted to the user based on the personal data received;
a first database for storing the personal data input by the user pursuant to the solicitation data displayed; and
an interactive communications network for facilitating the transfer of data between the first program controlled apparatus and the first and second servers;
at least one of the first and second servers housing a virtual portal for receiving the personal data and for transmitting the solicitation and discrete content data to the user over the interactive communications network.

In accordance with another aspect of the present invention, a method is provided for entering a sweepstakes that dynamically targets selected users for receipt of selected marketing data over an interactive communications network, the method comprising the steps of:
displaying a virtual process entry portal to the user for capturing selected personal data about the user;
receiving the requested personal data from the user;
validating and storing the user provided personal data;
pre-selecting marketing offers based on the user provided personal data;
displaying the pre-selected marketing offers to the user;
receiving data selected by the user corresponding to at least one of the pre-selected marketing offers displayed;
validating and storing the data selected by the user;
determining whether the data selected by the user matches data in a winning data set; and
if the data selected by the user matches data in the winning data set, notifying the user of the data match.

According to a further aspect of the present invention, a method is provided for entering a sweepstakes that solicits and captures selected personal information from a user over an interactive communications network, and dynamically selects and transmits a graphics based routine to the user based on the personal information, the method comprising the steps of:
viewing a process entry page of a virtual portal displayed by the system for capturing selected personal data about the user;
inputting the personal data requested on the entry page;
viewing marketing offers pre-selected by the system based on the personal data input;
selecting data corresponding to at least one of the pre-selected marketing offers displayed; and
if the data s elected by the user matches data in a winning data set, viewing winning notification data indicating the data match.

According to still another aspect of the present invention is a method of entering a sweepstakes that solicits and captures selected personal information from a user over an interactive communications network, and dynamically selects and transmits a graphics based routine to the user based on the personal information, the method comprising the steps of:
displaying a virtual process entry portal to the user for capturing a data set including at least one of selected biographic, geographic and/or psychographic data about the user;
receiving the requested information from the user;
validating and storing the user provided information;
pre-selecting marketing offers based on the user provided information;
displaying the pre-selected marketing offers to the user;
receiving information selected by the user corresponding to at least one of the pre-selected marketing offers displayed;
validating and storing the information selected by the user;
determining whether the information selected by the user matches information in a winning information set; and
if the information selected by the user matches information in the winning information set, notifying the user of the information match.

According to yet another aspect of t he p resent invention, a method is provided for entering a sweepstakes that solicits and captures selected personal information from a user over an interactive communications network, and dynamically selects and transmits a graphics based routine to the user based on the personal information, the method comprising the steps of:
viewing a process entry page of a virtual portal displayed by a system for capturing a data set including at least one of selected biographic, geographic and/or psychographic data about the user;
inputting the information requested on the entry page;
viewing marketing offers pre-selected by the system based on the information input;
selecting information corresponding to at least one of the pre-selected marketing offers displayed; and
if the information selected by the user matches information in a winning information set, viewing winning notification information indicating the information match.

According to a further aspect of the present invention, a program controlled sweepstakes entry apparatus is provided for soliciting and capturing selected personal information from a user over an interactive communications network and, based on the personal information, dynamically selecting and transmitting at least one graphics based routine to the user. The apparatus has programming for performing at least ten discrete functions including a first function for detecting user interaction, a second function for generating a virtual portal and soliciting selected personal information from the user, a third function for receiving the selected personal information in response to the second function, a fourth function for determining selected marketing content to be displayed to the user based upon the personal information input, a fifth function for accessing at least one data page in accordance with the content determined, a sixth function for transmitting the selected data page to the user over the network, a seventh function for displaying to the user the data page transmitted, an eighth function for determining whether the user's personal information qualifies him or her as a winner, a ninth function for transmitting winning notification data to the user, and a tenth function for displaying the winning notification data to the user.

In accordance with still a further aspect of the present invention is a hard drive of a program controlled apparatus housing a virtual portal for sweepstakes entry that solicits and captures selected personal information from a user over an interactive communications network and, based on the personal information, dynamically selects and transmits at least one graphics based routine to the user. The hard drive houses programming for performing at least ten discrete functions including a first function for detecting user interaction, a second function for generating a virtual portal and soliciting selected personal information from the user, a third function for receiving the selected personal information in response to the second function, a fourth function for determining selected marketing content to be displayed to the user based upon the personal information input, a fifth function for accessing at least one data page in accordance with the content determined, a sixth function for transmitting the selected data page to the user over the network, a seventh function for displaying to the user the data page transmitted, an eighth function for determining whether the user's personal information qualifies him or her as a winner, a ninth function for transmitting winning notification data to the user, and a tenth function for displaying the winning notification data to the user.

According to yet another aspect of the present invention is a plurality of carrier wave signals transmitted over an interactive communications network of a sweepstakes entry system, the carrier wave signals operating to solicit and capture selected personal information from a user over an interactive communications network and, based on the personal information, dynamically select and transmit at least one graphics based routine to the user. The signals house at least ten discrete functions including a first operation for detecting user interaction, a second operation for generating a virtual portal and soliciting selected personal information from the user, a third operation for receiving the selected personal information in response to the second operation, a fourth operation for determining selected marketing content to be displayed to the user based upon the personal information input, a fifth operation for accessing at least one data page in accordance with the content determined, a sixth operation for transmitting the selected data page to the user over the network, a seventh operation for displaying to the user the data page transmitted, an eighth operation for determining whether the user's personal information qualifies him or her as a winner, a ninth operation for transmitting winning notification data to the user, and a tenth operation for displaying the winning notification data to the user.

In accordance with another aspect of the present invention is a hard drive of a program controlled apparatus housing a virtual portal for sweepstakes entry that solicits and captures selected personal information from a user over an interactive communications network and, based on the personal information, dynamically selects and transmits at least one graphics based routine to the user, the hard drive housing programming for performing a method comprising the steps of:
capturing biographical information provided by the user, the biographical information including a data set corresponding to at least one of the user's name, postal address, telephone number, birth date and e-mail address;
capturing financial account information provided by the user that is necessary for electronically collecting and depositing money winnings of the user in a corresponding financial account;
validating the biographical information and account information provided by the user;
storing securely the captured biographical information and account information provided by the user on the hard drive;
based on the biographical information and account information, dynamically selecting and transmitting to the user at least one graphics based routine containing targeted banner offers, popup offers, or other dynamically served offers;
selecting a sweepstakes entry number corresponding to the user in exchange for providing his or her biographical and account information;
generating data derived from the user's biographical information, account information and the user's activities in response to the banner offers, popup offers, or other dynamically served offers;
storing securely the generated data derived from the user's biographical information, account information and the user's activities;
performing a winning check operation to determine whether the user is a sweepstakes winner by generating and selecting, for the account selected and at preset intervals, a winning number, conducting a winning number generation and selection integrity operation, comparing the sweepstakes entry number issued to the user to the winning number generated and selected, and if the sweepstakes entry number matches the winning number generated, then notifying the user that he or she is a sweepstakes winner and electronically depositing a selected quantity of money in the user's credit card, checking, debit card or like account; and
collecting and processing the biographical information, account information, generated data derived, sweepstakes entry number, winning number and all other information relating thereto and storing such information on the hard drive for current and future use.

According to still another aspect of the present invention, there is provided a hard drive of a program controlled apparatus, the hard drive housing a virtual portal for sweepstakes entry that solicits and captures selected personal information from a user over an interactive communications network and, based on the personal information, dynamically selects and transmits at least one graphics based routine to the user, the hard drive housing programming for performing a method comprising the steps of:
determining whether the user is to receive sweepstakes winnings and, if the user is to receive winnings, electronically depositing money corresponding to the sweepstakes winnings in a financial account of the user;
capturing biographical information provided by the user, the biographical information including a data set corresponding to at least one of the user's name, postal address, telephone number, birth date and e-mail address;
capturing financial account information provided by the user that is necessary for electronically depositing money winnings of the user in a corresponding financial account;
validating the biographical information and account information provided by the user;
storing securely the captured biographical information and account information provided by the user on the hard drive;
based on the biographical information and account information, dynamically selecting and transmitting to the user at least one graphics based routine containing targeted banner offers, popup offers, or other dynamically served offers;
selecting a sweepstakes entry number corresponding to the user in exchange for providing his or her biographical and account information;
generating data derived from the user's biographical information, account information and the user's activities in response to the banner offers, popup offers, or other dynamically served offers; and
storing securely the generated data derived from the user's biographical information, account information and the user's activities.

In accordance with yet another aspect of the present invention is a sweepstakes entry system for dynamically targeting selected entrants for receipt of selected marketing data over an interactive communications network, the system having at least one hard drive for housing a customer database of sweepstakes entrants assembled by operation of the system over the network, the database containing each entrant's biographical information, information sufficient to electronically deposit winnings in at least one of the user's credit card, checking and/or debit card accounts, and generated data derived from the user's biographical information, account information and the user's activities in response to banner offers, popup offers, or other dynamically served offers presented to the entrant during operation of the system over the network.

Still a further aspect of the present invention relates to a method for dynamically generating and serving graphics based advertising offers to a user over an interactive communications network based upon information previously collected from the user through a virtual portal. The method comprises the steps of:
i. periodically generating activity pattern data regarding the user from activity history data to represent product preference, payment preference, maximum purchase amount preference or like information;
ii. storing the user activity data in a set of activity history database tables;
iii. defining advertising offers using targeting rules governing appropriateness, frequency and general conditions under which the offers may be presented to the user visiting the virtual portal;
iv. determining which subset and execution sequence of a selected offer's targeting rule are applicable for a given user;
v. executing the applicable rules against the activity history and pattern data resulting in a positive or negative condition for each rule or rule combination; and
vi. using add serving scripts, applying the rules generated and returned so as to determine whether a selected marketing offer is appropriate for the user.

It is, therefore, an object of the present invention to provide an automated sweepstakes entry system for dynamically targeting selected entrants for receipt of selected marketing data in exchange for providing selected personal information over an interactive communications network.

Another object of the present invention is to provide a program controlled sweepstakes entry apparatus, a system and a method for compiling a database containing each entrant's biographical information, information sufficient to electronically deposit winnings in at least one of the user's credit card, checking and/or debit card account, and generated data derived from the user's biographical information, account information and the user's activities in response to banner offers, popup offers, or other dynamically served offers presented to the entrant during operation of the system over an interactive communications network.

A further object of the present invention is to provide a database containing each entrant's biographical information, information sufficient to electronically deposit winnings in at least one of the user's credit card, checking and/or debit card account, and generated data derived from the user's biographical information, account information and the user's activities in response to banner offers, popup offers, or other dynamically served offers presented to the entrant during operation of the system over an interactive communications network.

Still another object of the present invention is to provide a sweepstakes entry system and a method for enabling a business to consistently and effectively solicit selected personal information from a user and, based upon the information obtained, allow the business to generate a user profile based on geographic, demographic and/or psychographic parameters for targeting the user for future on-line advertising or the like.

Another object of the present invention is to provide a program controlled apparatus, system and method for collecting detailed information about customers, in general, so that a detailed customer profile can be created.

Yet a further object of the present invention is to provide a novel method of obtaining customer information by soliciting personal information from customers through gaming and prize reward systems.

Yet another object of the present invention is to improve the speed and quality of data transfer between merchants, customers and their financial institutions.

Still another object of the present invention is to provide an automated apparatus, system and method for satisfying the need of many businesses for obtaining information about their customers and compiling customer profiles, simply, efficiently and economically.

Another object of the present invention is to maximize automation of customer data collection and compiling of customer profiles and, thereby, achieve greater efficiency and cost savings without sacrificing accuracy of the data or of the profiles compiled, and with minimal human intervention.

A further object of the present invention is to provide a novel apparatus, system and method that overcomes the reluctance of many users to provide personal information over the Internet, while providing on-line businesses the information needed to target appropriate customers for information and assemble user profiles based on the same.

Yet a further object of the present invention is to provide a novel system and method for soliciting personal information from prospective customers by rewarding them with prize winnings but without the unrealistic expectations created in such customers as are associated with conventional gaming and prize reward systems.

The present invention will now be further described by reference to the following drawings which are not intended to limit the accompanying claims.

### BRIEF DESCRIPTION OF THE DRAWINGS

FIG. 1 is a flow diagram of a system for soliciting selected personal information from users over an interactive communications network and dynamically transmitting graphics based applets to the users for displaying content to them based on their personal information, according to one aspect of the present invention;

FIG. 2 is a schematic illustration of an apparatus of the system set forth in FIG. 1, according to one aspect of the present invention, showing programming components and data sets;

FIG. 3 is a schematic illustration of an apparatus of the system set forth in FIG. 2, showing components of the first and second programming;

FIG. 3A is a schematic illustration of discrete content data and components, according to the present invention;

FIG. 4 is a flow diagram of a multi-server system for soliciting selected personal information from users over an interactive communications network and dynamically transmitting graphics based applets to the users for displaying content to them based on their personal information, in accordance with the present invention;

FIG. 5 is a schematic illustration of an apparatus of the system set forth in FIG. 1, according to another aspect of the present invention;

FIG. 6 is a schematic illustration of an apparatus of the system set forth in FIG. 1, according to a further aspect of the present invention;

FIG. 7 is a flow diagram showing operation of the system of FIG. 1, according to one aspect of the present invention;

FIG. 8 is a flow diagram showing operation of the system of FIG. 1, according to another aspect of the present invention;

FIG. 9 is a flow diagram showing operation of the system of FIG. 1, in accordance with a further aspect of the present invention;

FIG. 10 is a flow diagram showing a process for dynamic offer generation, according to one aspect of the present invention;

FIG. 11 is a schematic illustration of an apparatus of the system set forth in FIG. 3, according to a further aspect of the present invention, showing process flow of the system in accordance with one aspect of the present invention; and

FIG. 12 is a flow diagram showing a method for direct deposit promotions, according to one aspect of the invention.

The same numerals are used throughout the figure drawings to designate similar elements. Still other objects and advantages of the present invention will become apparent from the following description of the preferred embodiments.

### DETAILED DESCRIPTION OF THE PREFERRED EMBODIMENTS

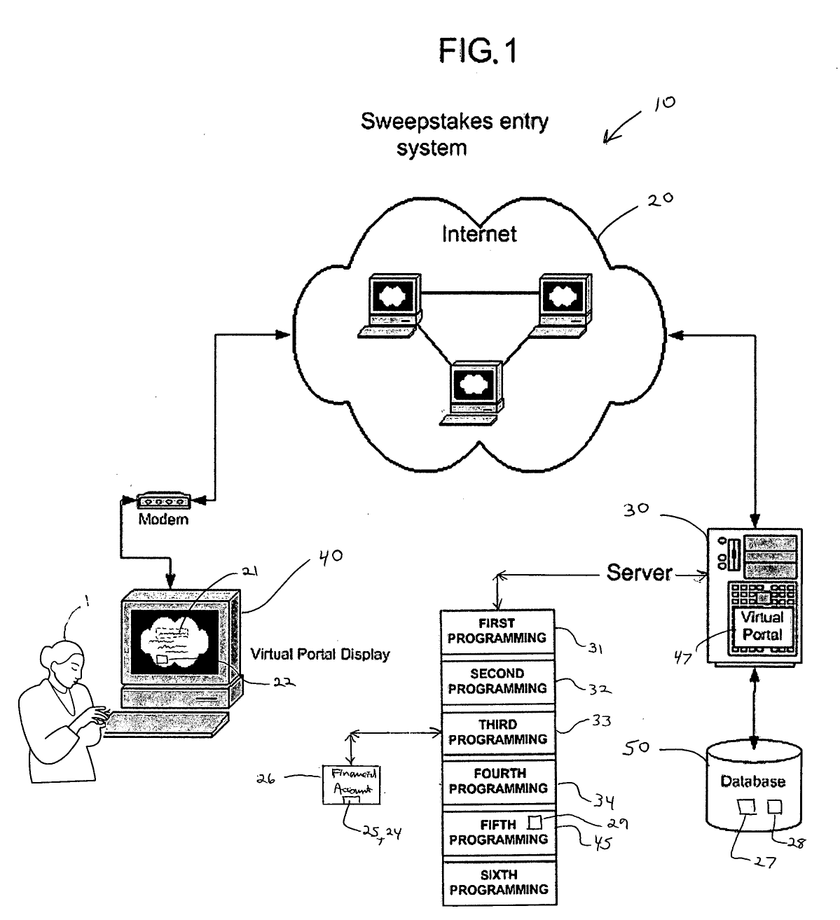

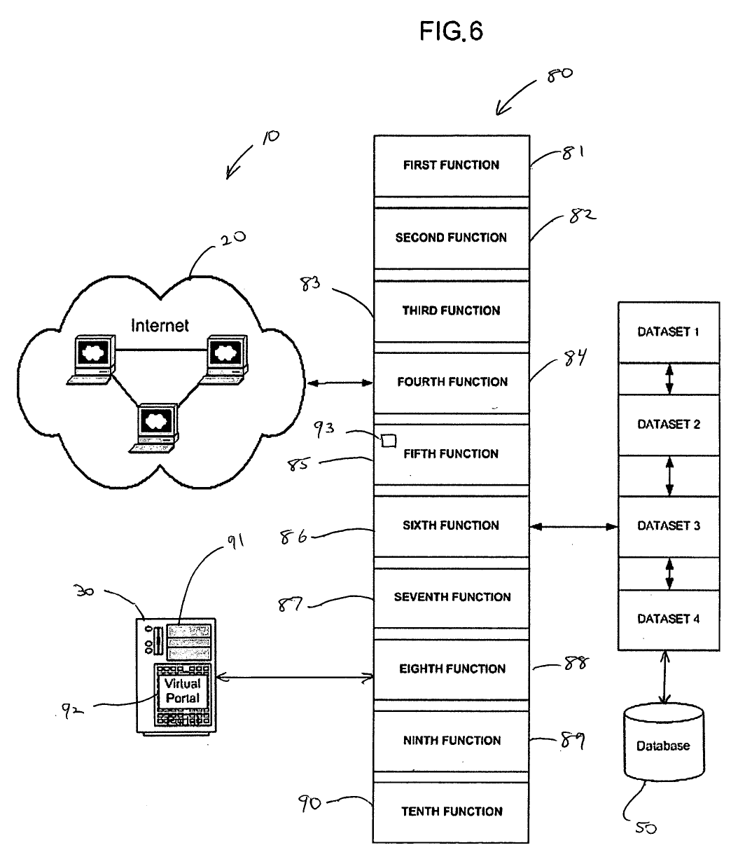

Referring now to the drawings and more particularly to FIGS. 1-12, there is shown generally, in accordance with the present invention, a specific, illustrative sweepstakes entry system 10 for soliciting and capturing selected personal information from a user 1 over an interactive communications network 20 such as the Internet and, based on the personal data or information 21 retrieved, dynamically selecting and transmitting selected graphics based applets 22 to the user. At a high level, the system provides a network based, e.g., Web based, arrangement that allows customers to participate in a sweepstakes and collect winnings directly through a customer provided, electronic payment vehicle. At the kernel of the system, as shown in FIG. 1, is a server 30, e.g., in the form of1 1U SuperMicroDual-Xeon 6012-P6 Chassis with two Intel Xeon MP 2.2 Ghz microchips, up to three 36 GB-74GB SCSI 7200 rpm hard drives, four DDR 512 MB PC2200 RAM, and an Adaptec 2005s RAID card (if necessary) and operating with conventional server software such as Windows 2000, having first programming 31 for generating solicitation data 23 and for transmitting the data to a user. Second programming 32 is provided for determining whether the user is to receive sweepstakes winnings 24. The server is, in addition, equipped with third programming 33 for electronically depositing funds 25, e.g., electronic cash, corresponding to the sweepstakes winnings in a financial account 26 of the user. Optionally, a real-time winnings check module 34 is provided for storing the user's account number information 27, ensuring the integrity of winning number 28 selection and verifying that the winning number selected indeed belongs to an existing user account.

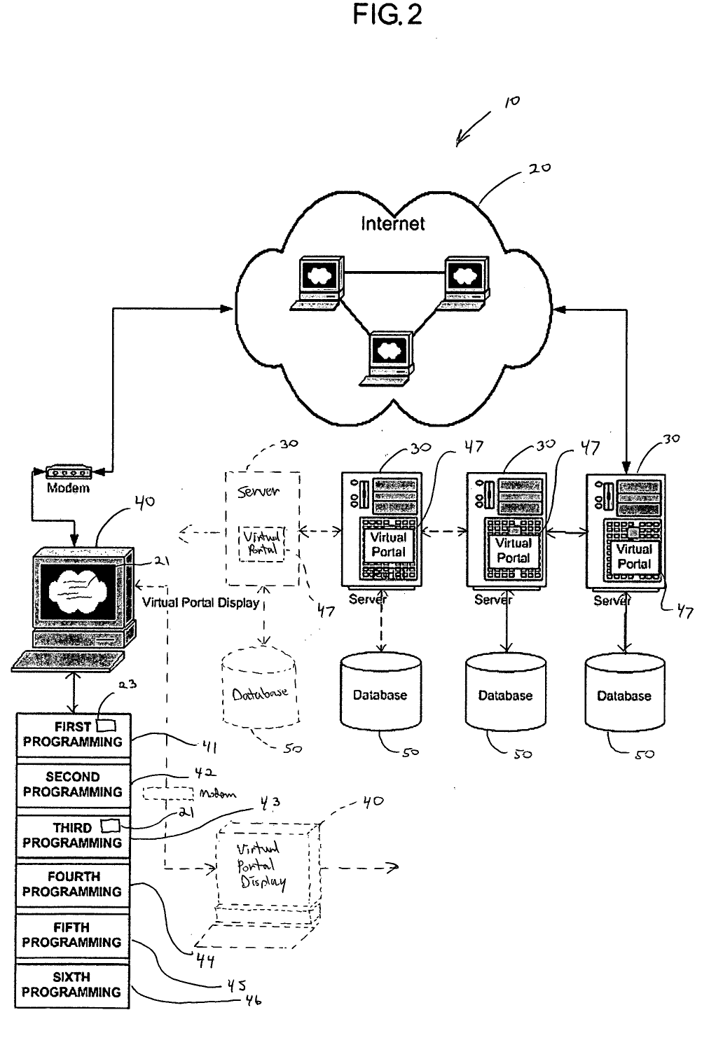

As best seen in FIG. 2, the system is provided with at least one program controlled apparatus 40, e.g., a conventional desktop or laptop personal computer or traditional Internet ready server having Windows XP, Windows NT or like operating system. The apparatus has first programming 41 for receiving the solicitation data 23 from the apparatus, i.e., server 30. Second programming 42 is used to display the data to the user in a selected data format, e.g., a conventional data format. Third programming 43 is also provided for receiving personal data 21 input by the user, and fourth programming 44 for transmitting the personal data to the server. In this connection, server 30 is additionally programmed, fifth 45, to process selected personal data received from the user in response to the solicitation data, and sixth 46, to transmit discrete content data 29 targeted to the user based upon the personal data received. The server also houses a virtual portal 47 for receiving the personal data and for transmitting the solicitation and discrete content data to the user over the interactive communications network. Another component of system 10 is a database 50, e.g., a conventional database server suitable for Internet-related applications having a 2U SuperMicro Dual-Xeon 6022-P6 Chassis with two Intel Xeon MP 2.2 Ghz microchips, up to six 36 GB SCSI 7200 rpm hard drives equipped with Microsoft SQL 2000 software or the like, four DDR 1024 MB PC2200 RAM and an Adaptec 2005s RAID card, for storing the personal data input by the user pursuant to the solicitation data displayed. Notably, transfer of data between the program controlled apparatus and the server is facilitated via interactive communications network 40.

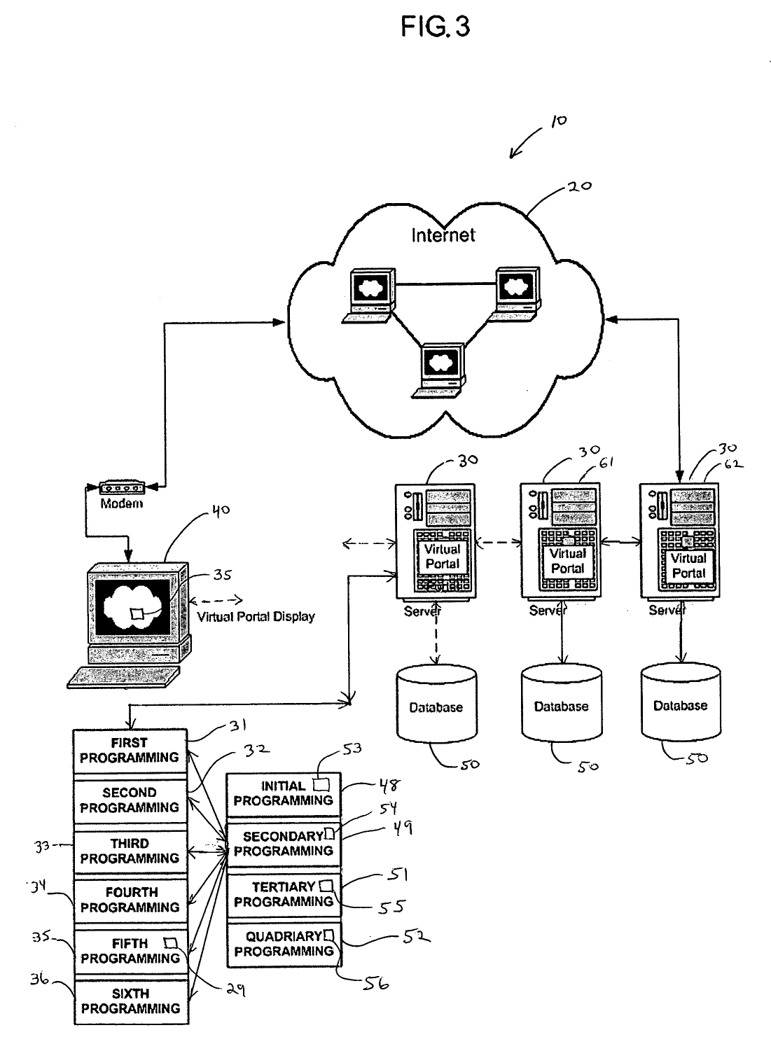

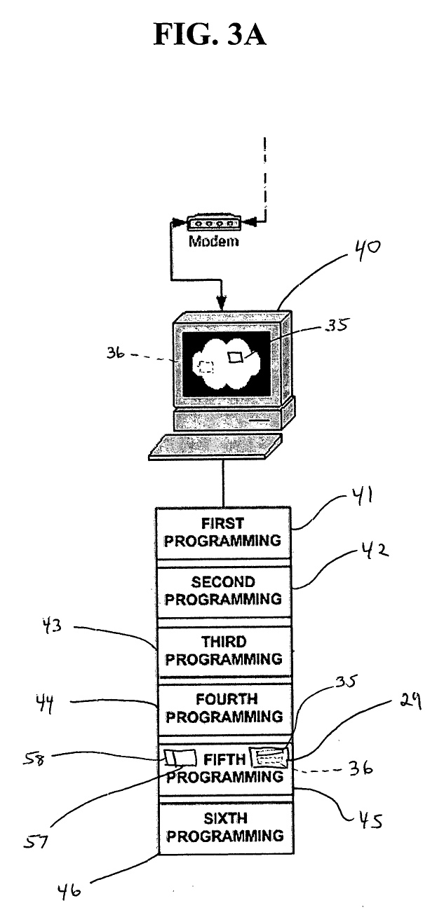

As illustrated in FIG. 3, it is preferred that at least one of first and second programming 31 and 32, respectively, of server 30 have initial programming 48 for capturing biographical information 53 input by the user, secondary programming 49 for capturing geographic information 54 input by the user, and/or tertiary programming 51 for capturing psychographic information 55 input by the user. It is also considered desirable that quattronary programming 52 be provided for electronically capturing the user's choice of mode of payment 56 for collecting sweepstakes winnings.

According to one embodiment of the present invention, shown in FIG. 3A, discrete content data 29 includes at least one banner type advertising display 35, e.g., an applet or applet based routine, based upon the personal information. Alternatively or concurrently, the discrete content data includes one or more popup type advertising displays 36, e.g., also related to or powered by an applet, grounded upon the personal information. In addition, the content data comprises at least one dynamically served offer type advertising display 37, e.g., applet or applet-like, also established according to the personal information input.

In order to generate the discrete content data, specialized programming 57 is preferably provided on the server, namely, for generating at least one offer type advertising display to be dynamically served upon the user. At least one function 58 is also provided for identifying and generating marketing opportunities, based upon the personal information and selected data generated by the programming for identifying and generating marketing opportunities.

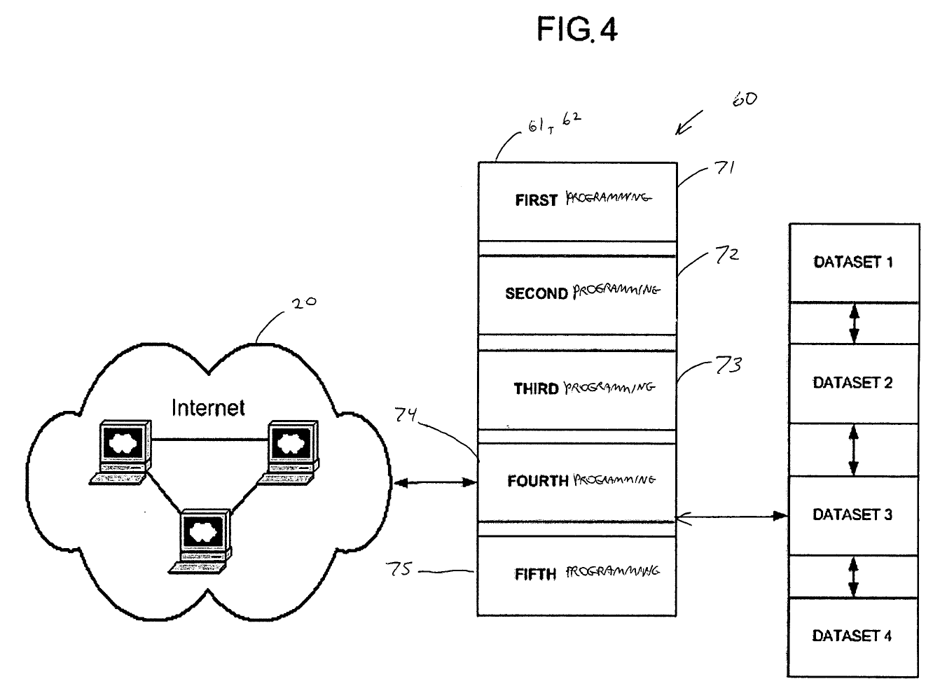

In an alternative embodiment, set forth in FIGS. 3 and 4, two or more servers 30 are provided. According to one aspect of the present invention, for instance, a first server 61 is provided desirably having first programming 71 for generating solicitation data and for transmitting the data to a user. Second programming 72 determines whether the user is to receive sweepstakes winnings, and third programming 73 effects the electronic deposit of money corresponding to the sweepstakes winnings in a financial account of the user. A second server 62 houses programming 74 for processing selected personal data received from the user in response to the solicitation data and programming 75 for transmitting discrete content data targeted to the user based on the personal data received.

According to this multi-server arrangement, the first programming 31 of program controlled apparatus 30 provides for receipt of solicitation data from the first server, and fourth programming 44 transmits the personal data to the second server. At least one of the first and second servers 61, 61, respectively, houses virtual portal 47 for receiving the personal data and for transmitting the solicitation and discrete content data to the user. Interactive communications network 20 facilitates the transfer of data between program controlled apparatus 40 and each of the first and second servers.

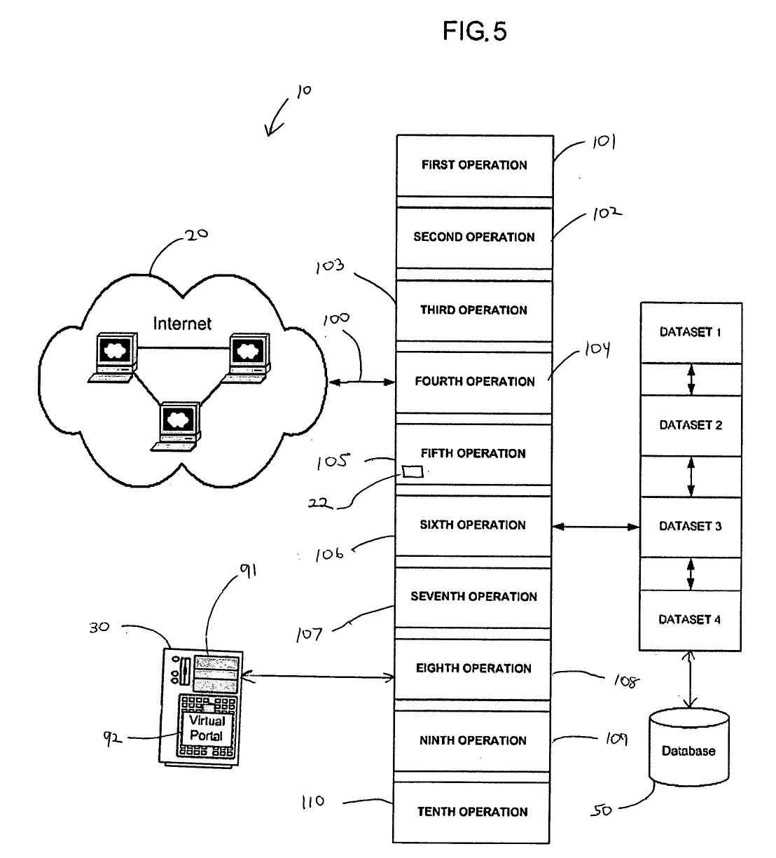

Another embodiment of the present invention relates to a program controlled sweepstakes entry apparatus 80 for soliciting and capturing selected personal information from a user over an interactive communications network and, based on the personal information, dynamically selecting and transmitting to the user at least one graphics based routine. As shown generally in FIG. 5, at the core of the apparatus is programming for performing a series of discrete operations. According to one aspect of the present invention, at least ten discrete functions are provided, including, but not limited to: a first function 81 for detecting user interaction; a second function 82 for generating the virtual portal and soliciting selected personal information from the user; a third function 83 for receiving the selected personal information in response to the second function; a fourth function 84 for determining selected marketing content to be displayed to the user based upon the personal information input; a fifth function 85 for accessing at least one data page in accordance with the content determined; a sixth function 86 for transmitting the selected data page to the user over the network, a seventh function 87 for displaying to the user the data page transmitted; an eighth function 88 for determining whether the user's personal information qualifies him or her as a winner; a ninth function 89 for transmitting winning notification data to the user; and a tenth function 90 for displaying the winning notification data to the user.

A hard drive 91 of apparatus 80, e.g., a conventional PC or server drive, preferably houses a virtual portal 92 for sweepstakes entry. More particularly, the portal enables virtual interaction, namely, the solicitation and capture of selected personal information from a user over the interactive communications network. Based upon the information obtained, the portal also enables dynamic selection and transmission of at least one graphics based routine 93 to the user. The hard drive also houses programming for performing the at least ten discrete functions including: the first function for detecting user interaction; second function for generating a virtual portal and soliciting selected personal information from the user; third function for receiving the selected personal information in response to the second function; fourth function for determining selected marketing content to be displayed to the user based upon the personal information input; fifth function for accessing at least one data page in accordance with the content determined; sixth function for transmitting the selected data page to the user over the network; the seventh function for displaying to the user the data page transmitted; eighth function for determining whether the user's personal information qualifies him or her as a winner; ninth function for transmitting winning notification data to the user; and, finally, the tenth function for displaying the winning notification data to the user. It is noted that the fourth function identifies and generates marketing opportunities based upon both the personal information and the selected data generated by the programming for identifying and generating marketing opportunities.

Programming of the present invention including, but not limited to, functions, steps, operations or like Web applications, is preferably supported by and operates from a platform of conventional middleware, e.g., ColdFusion MX 6.1, a software product of MacroMedia, Inc. This platform or operating environment has been found particularly advantageous for development of Web based applications, within the spirit and scope of the present invention.

In accordance with still another embodiment of the present invention, set forth generally in FIG. 5, a plurality of carrier wave signals 100 of the sweepstakes entry system are characteristically transmitted over the interactive communications network pursuant to conventional wireless and selected land-based operations via the Internet. These signals operate to enable the user to solicit and capture selected personal information from a user over an interactive communications network and, based on the personal information, dynamically select and transmit at least one graphics based routine to the user, the signals housing at least ten discrete functions including a first operation 101 for detecting user interaction, a second operation 102 for generating a virtual portal and soliciting selected personal information from the user, a third operation 103 for receiving the selected personal information in response to the second operation, a fourth operation 104 for determining selected marketing content to be displayed to the user based upon the personal information input, a fifth operation 105 for accessing at least one data page in accordance with the content determined, a sixth operation 106 for transmitting the selected data page to the user over the network, a seventh operation 107 for displaying to the user the data page transmitted, an eighth operation 108 for determining whether the user's personal information qualifies him or her as a winner, a ninth operation 109 for transmitting winning notification data to the user, and a tenth operation 110 for displaying the winning notification data to the user.

While the present invention has been shown and described with reference to a sweepstakes entry system specifically for soliciting and capturing selected personal data from a user over an interactive communications network and, based on the personal data retrieved, dynamically selecting and transmitting selected graphics based applets 22 to the user, it is understood that other systems desirous of personal or other selected information desired from a user may utilize the various scenarios described herein, within the spirit and scope of the present invention. For instance, the invention is considered applicable to other gaming systems as well as non-gaming systems which would benefit from an information/reward based arrangement as provided herein, giving consideration to the purpose for which the present invention is intended. In addition, other software based vehicles for transmitting selected marketing offers, whether text based, non-graphics based, animated, of limited duration and/or all of the above, are considered consistent with the principles set forth herein.

Generally speaking, the system according to various aspects of the present invention is preferably supported by conventional Internet security software, such as standard HTTPS Protocol equipped with hardware and/or software based VeriSign®SSL Certification, in combination with conventional internal networking security software. Such software is well know by those skilled in the art and further description is considered unnecessary for purposes of illustrating the present invention.

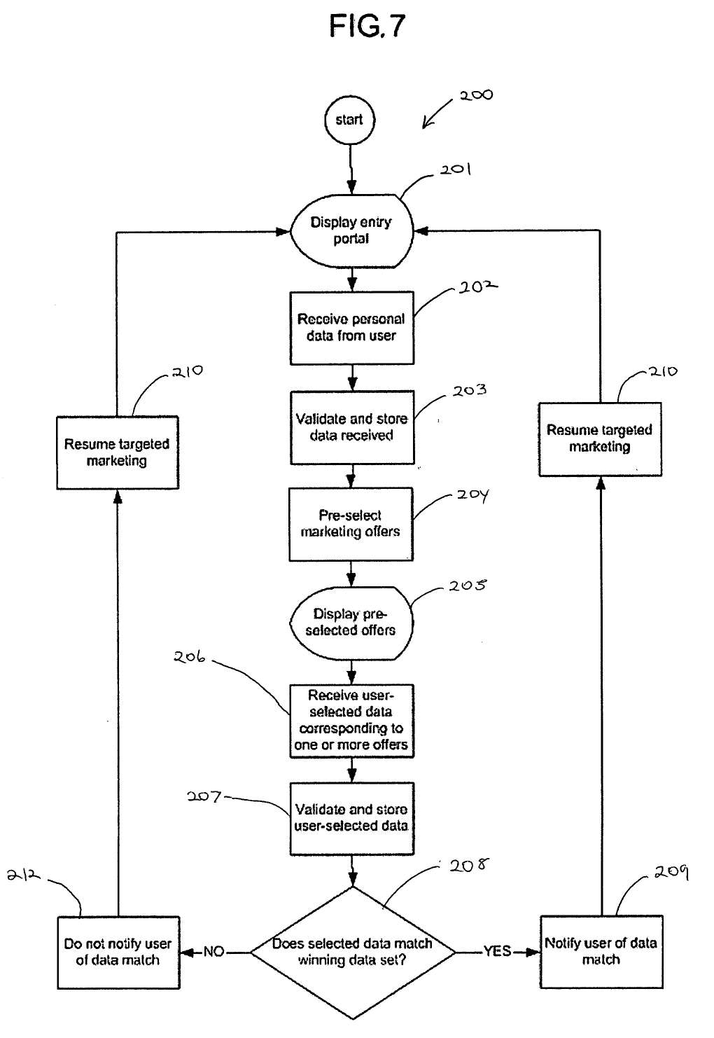

Turning now to another aspect of the present invention, a method 200 is provided for entering a sweepstakes that solicits and captures selected personal information from a user over interactive communications network 20, and that dynamically selects and transmits graphics based routine 93 to the user based on personal information 21. Initially, from the system perspective, a virtual process entry portal, e.g., a Web page of a program controlled interactive system, is displayed 201 to the user, the portal requesting and capturing his or her personal data. A method of this general description is illustrated in FIG. 7. Upon entry of selected personal data by the user, the system receives 202 the data which is then validated and stored 203 in a database. System validation includes matching, for instance, of user address, telephone number and/or electronic account information input by the user with corresponding user information on file in the database.

Next, the system pre-selects 204 marketing offers based on the user provided personal data, and displays 205 the same to the user. The decision making function or operation for offer pre-selection is desirably performed using a conventional algorithm which, based upon the information input, determines according to geographic, demographic and/or psychographic models those goods and/or services (or general class of goods and/or services) that the user is most likely to purchase. Virtual marketing offers such as pop-ups, banner ads or the like which correspond to the respective goods and/or services are then chosen and transmitted to the user. The user selects at least one of the pre-selected marketing offers, the system receiving 206, and then validating and storing 207 the user's selection in the database. Storage of all user provided information includes secure storage, e.g., using Secure Shell (SSH) and/or the like, of user account information, storage of all user personal data, both provided by the user and derived from user activity. The information collected is categorized, processed and stored for future use

Thereafter, the system determines 208, preferably in real-time, whether the data selected by the user matches data in a winning data set, i.e., performs a winning check verification. In particular, the process followed includes, but is not necessarily limited to, the steps of executing a conventional algorithm for selecting and generating winnings numbers at preset but configurable intervals. According to one embodiment of the present invention, the algorithm is a traditional random number generator. In another embodiment, each vehicle for electronic collection, as specified by the user, is supported by a specialized algorithm, e.g., a Random Number Generator function of ColdFusion MX6.1's integrated development environment, depending upon the vendor or other service used. More specifically, an “account” number is generated in a composite fashion, such as card type and account number, or bank ID and account number. If possible, the composite “account” number is validated to ensure, where possible, that the winning number indeed belongs to an existing and defined account entity.

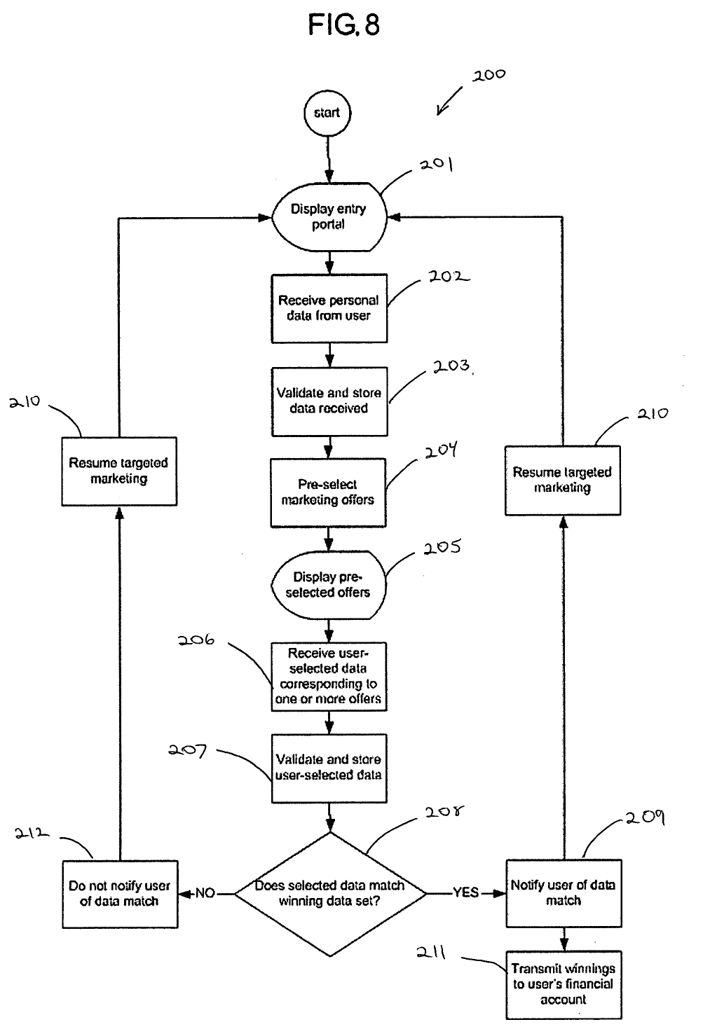

A first conventional process is then followed to ensure integrity of winning number selection and generation, and a second conventional operation for notifying winning users. If there is, indeed, a match between the data selected and that in the winning data set, the system desirably notifies 209 the user of the match such as by an e-mail message generated by a conventional notification algorithm and targeted marketing operations resume 210, namely, the user is returned to the display entry portal. Optionally, as shown in FIG. 8, the system also transmits 211 the winnings to a selected financial account of the user. On the other hand, if there is not a match, the user is not notified 212 and targeted marketing operations resume as the user is returned to the entry portal.

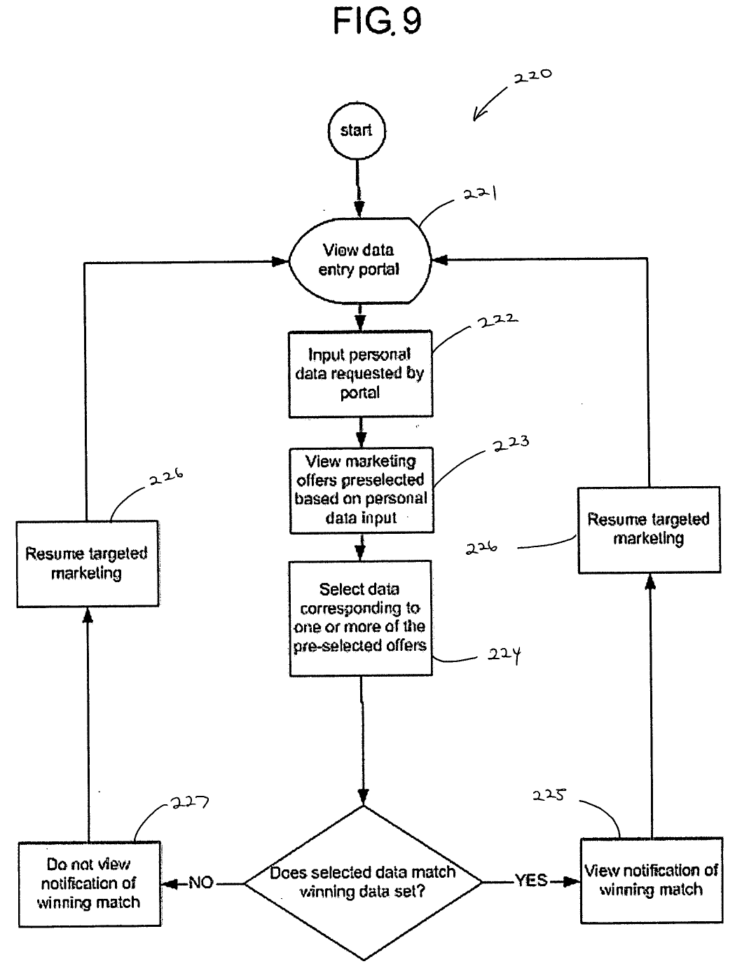

According to another aspect of the present invention, as shown in FIG. 9, a method 220 is practiced, from the user's perspective, for entering a sweepstakes that solicits and captures selected personal information from a user over an interactive communications network, and that dynamically selects and transmits a graphics based routine to the user based on the personal information. First, the user views 221 a process entry page of the virtual portal, e.g., a Web page, which is initiated and displayed by the program controlled interactive system, for capturing selected personal data about the user. Next, the user inputs 222 the personal data requested on the page. Optionally, the requested personal information includes the user's choice of mode of payment for collecting sweepstakes winnings.

Thereafter, the system determines, based upon the information input, those goods and/or services (or class of goods and/or services) that the user is most likely purchase, and displays corresponding virtual marketing offers to the user. Preferably, in this context the step of pre-selecting marketing offers based upon user provided personal information, from the system perspective, includes the steps of identifying and generating marketing opportunities based upon the personal information and selected data generated by the programming for identifying and generating marketing opportunities. In one embodiment, the pre-selected marketing offers displayed include at least one banner type advertising display. Alternatively or concurrently, at least one popup type advertising display is presented to the user. Further alternatively or concurrently, the pre-selected marketing offer is at least one dynamically served offer type advertising display.

Finally, the user views 223 the marketing offers pre-selected by the system, and selects 224 data corresponding to at least one of the pre-selected marketing offers displayed. The system determines whether the data selected by the user matches data in a winning data set and performs a winning check verification. If the data selected matches data in a pre-selected winning data set, then the user views 225 winning notification data indicating that there has been a data match, and the system returns 226 the user to the data entry portal. However, if there is no match, then the user does not view 227 a winning match notification and is returned 226 to the entry portal.

Alternatively or concurrently, the virtual process entry portal displayed to or viewed by the user for capturing a personal data set includes at least one of selected biographic, geographic and/or psychographic data about the user.

Personal information, according to various aspects of the present invention, may take a variety of forms, depending upon the data model used and the business desiring the information. Preferably, the personal information sought includes the user's biographical information which may include, but is not limited to, his or her name, street address, postal address, e-mail address, data of birth and/or the user's choice of electronic vehicle for collection of winnings payment. In this connection, the user desirably provides one or more credit card numbers with respective expiration dates and/or other verification information characteristic of such card information. Another option for receiving payment is a checking account number of the user's bank or other financial institution including bank routing number and any other particulars required for electronically crediting (or debiting) the user's checking account. A further choice for collection of winnings may be the account number of a debit card of the user—typically also available from the user's bank or other financial institution. Additional options for electronic collection include a virtual collection and payment service such as PAYPAL, ECHECK, VISA, MASTERCARD or like services.

It is preferred that the user be presented with one or more targeted marketing offers based upon the personal information input. This includes not only banner and popup type offers, as indicated above, but also dynamically based offers. For example, dynamically served offers are provided dependent upon user supplied information such as his or her telephone number, type of collection arrangement (i.e., credit card, debit card, checking account or the like), age, gender, address or any part thereof (i.e., street, city, state, zip code, region, country, etc.). As for other dynamic offers that may be used, such include offers generated by a conventional algorithm for identifying and generating marketing opportunities according to user provided data and algorithmic derived data. Algorithms of this type are known by those skilled in the art and further description is unnecessary for purposes of illustrating the present invention.

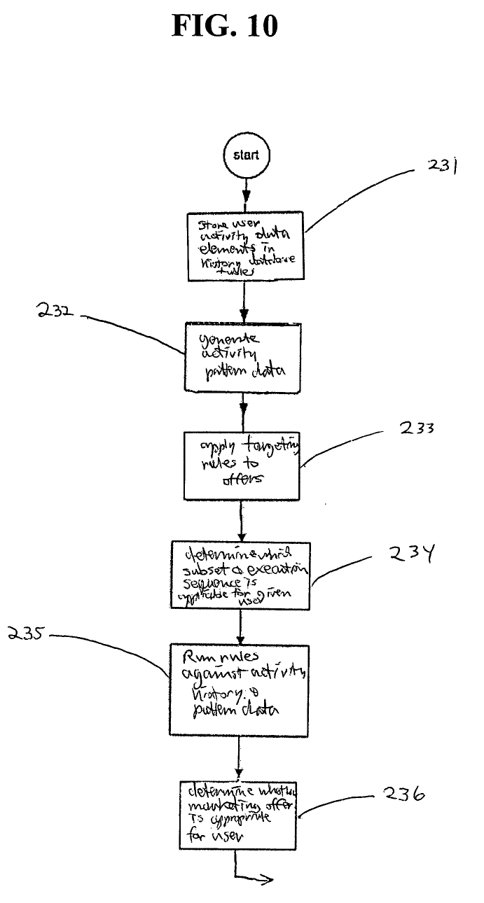

According to one embodiment, shown in FIG. 10, dynamic offers are generated 230 by initially storing 231 all user activity data elements in a set of activity history database tables. It is considered desirable that activity “pattern” data be generated 232 periodically from activity history data to represent information such as product preference, payment preference, maximum purchase amount preference and/or the like. Such offers are defined 233 using targeting rules that govern appropriateness, frequency and general conditions under which they may be presented to each user visiting the virtual portal, i.e., Web site. Additional algorithm(s) also know by those skilled in the art determine 234 which subset and execution sequence of a selected offer's targeting rule are applicable for a given user. The applicable rules are then executed or run 235 against activity history and pattern data resulting in a positive or negative condition for each rule or rule combination. Finally, add serving scripts apply the rules generated and returned by the algorithm(s) to determine 236 whether a selected marketing offer is appropriate for a user.

The present invention has been shown and described with reference to particular conventional hardware, software and operation systems, the invention and its operation, as will be appreciated by those skilled in the art, not being dependent upon any specific hardware, operating system, software platform or product according to the functionality and features which may be available. It is, therefore, understood that the system, according to various aspects of the present invention, may be implemented in its entirety using any hardware, operating system and software platform, whether conventional or non-conventional, giving consideration to the purpose for which the present invention is intended.

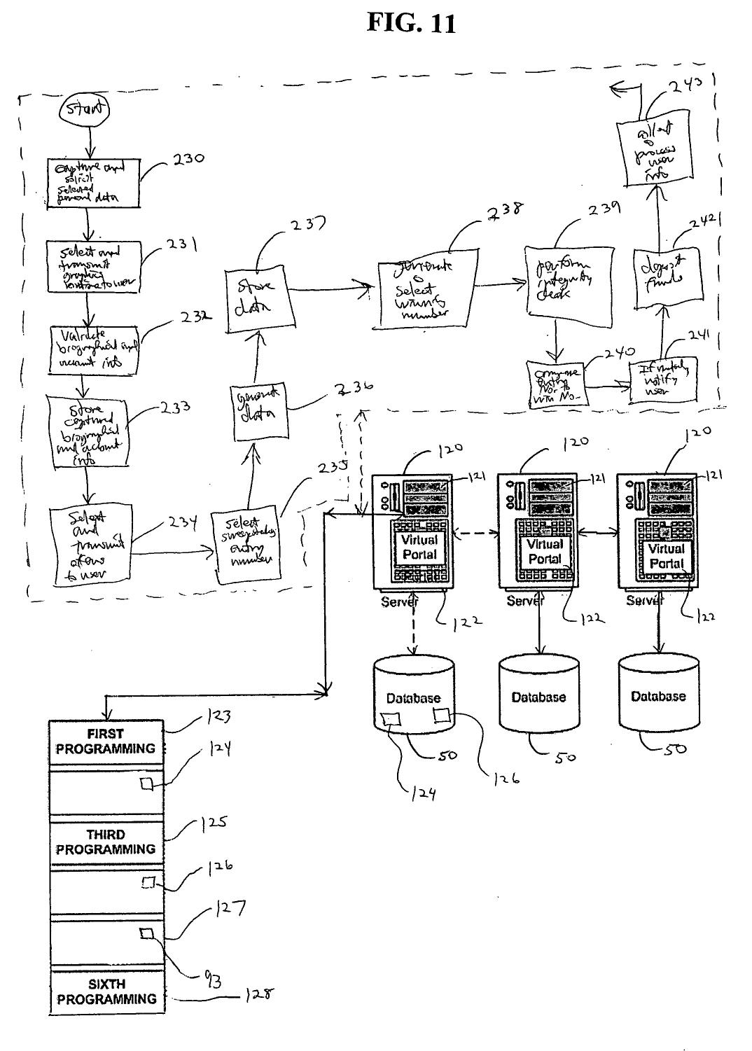

Still a further embodiment of the present invention relates to a hard drive 121 of a program controlled apparatus 120. As best seen in FIG. 11, the hard drive houses a virtual portal 122 for sweepstakes entry that solicits and captures 230 selected personal information from a user over interactive communications network 20 and, based on the personal information, dynamically selects and transmits 231 at least one graphics based routine 93 to the user. More particularly, the hard drive houses programming 123 for capturing biographical information provided by the user, the biographical information including at least one data set 124 corresponding to the user's name, street address, postal address, telephone number, birth date and e-mail address. Also housed by the hard drive is programming 125 for performing the steps of capturing financial account information provided by the user that is necessary for electronically collecting and depositing money winnings of the user in a corresponding financial account. The programming validates 232 the biographical information and account information provided by the user, and stores 233 securely the captured biographical information and account information provided by the user on the hard drive.

Based on the biographical information and account information received, the at least one graphics based routine containing targeted banner offers, popup offers, or other dynamically served offers is dynamically selected and transmitted 234 to the user. A sweepstakes entry number 126 corresponding to the user is then selected 235 in exchange for providing his or her biographical and account information. Programming 127 on the hard drive generates 236 data derived from the user's biographical information, account information and the user's activities in response to the banner offers, popup offers, or other dynamically served offers, and stores 237 securely the data derived from the user's biographical information, account information and the user's activities.

Thereafter, a winning check operation is performed in order to determine whether the user is a sweepstakes winner. This is accomplished, for example, by generating and selecting 238, for the account selected and at preset intervals, a winning number, conducting 239 a winning number generation and selection integrity operation, and comparing 240 the sweepstakes entry number issued to the user to the winning number generated and selected. If the sweepstakes entry number matches the winning number generated, then the user is notified 241 that he or she is a sweepstakes winner and a selected quantity of money is electronically deposited 242 in the user's credit card, checking, debit card or like account. Finally, a step of collecting and processing 243 the biographical information, account information, generated data derived, sweepstakes entry number, winning number and all other information relating thereto is performed, such data and information being stored 244 on the hard drive for current and future use.

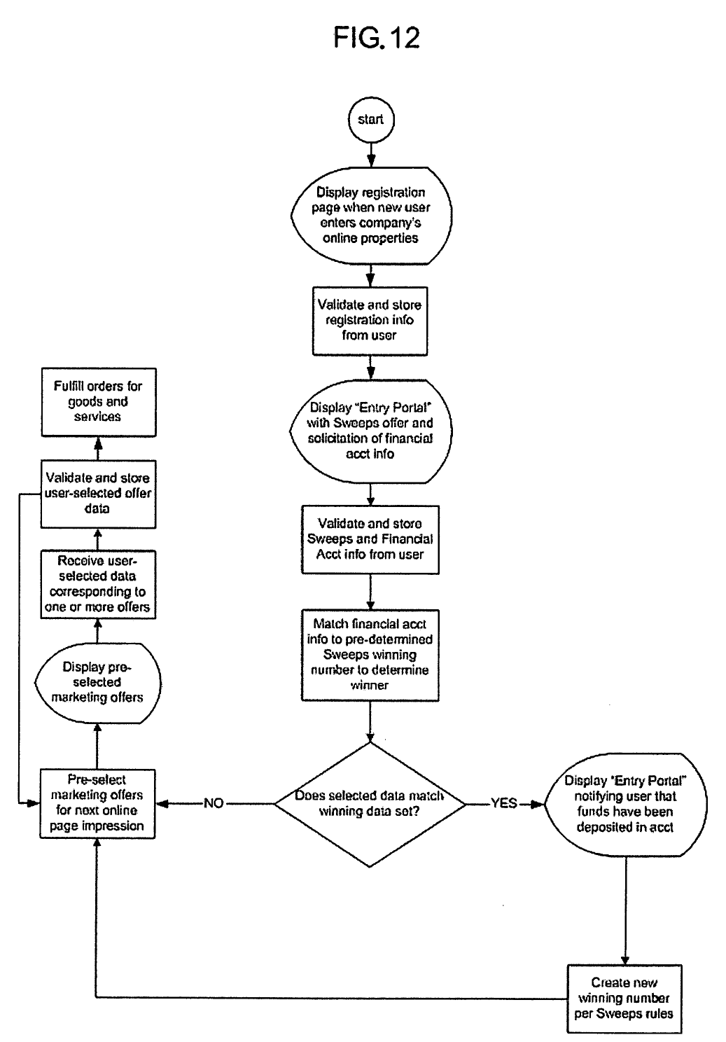

Yet another feature of the present invention concerns direct deposit lottery promotions. In one embodiment, a user arrives at a Web page such as a lottery site of a company providing the promotion service (a.k.a. an online Web property of the company). An arrangement of this general description is illustrated in FIG. 12. The user is asked to provide selected personal information in exchange for a right to participate in the lottery. After registering, the user is shown an offer soliciting financial account information in exchange for entering a sweepstakes. When the user enters the sweepstakes by providing his or her account number, the number is matched to the pre-selected winning sweepstakes number. If the user wins, then funds are deposited directly in an account provided as the sweepstakes entry. Regardless of whether the user wins or loses, he or she is subsequently show targeted marketing offers intended to take advantage of the company's possession of the user's credit card or ACH information. If the user agrees to one or more of these offers, he or she typically clicks on a virtual “Accept” button displayed on the Web page, and the company charges the cost of the offer to the user's financial account stored in the company's database. This function may operate during the same user session as the Sweepstakes entry, or during any subsequent visit to any of the company's other online properties.

More particularly, in one embodiment, when a new user enters a virtual portal of a lottery Web site, a registration page is displayed to the user. The user then inputs selected registration information which is validated and stored. Next, ENTRY PORTAL is displayed with one or more selected Sweepstakes offers and an accompanying solicitation of financial account information from the user. According to one arrangement, ENTRY PORTAL is displayed as a Web page popup. Upon inputting the information desired, the Sweepstakes and financial account information from the user is validated and stored. Financial account information validation may include, but is not limited to, checksum calculations on account number and pre-authorization of credit card as well as comparisons of personal information to commercial credit databases. The financial account information is then matched with or compared to a pre-determined Sweepstakes winning number to determine whether the user is a winner. Specifically, the decision process determines whether the data matches the winning data set, a lottery system in accordance with the present invention automatically checking the user submitted data against the pre-determined winning number. If there is a match, ENTRY PORTAL is displayed,e.g., as a Web page popup, with notification that funds have been deposited in the user's account. Alternatively or concurrently, notifications are transmitted to company personnel using a conventional automated e-mail program.

If there is no match, a new winning number is created according to governing Sweepstakes rules. Those skilled in the art will appreciate that compliance with legal requirements as imposed by regional Sweepstakes rules is typically required, and that from time to time changes may occur in such requirements which may necessitate changes in the manner by which winning numbers are generated.

Thereafter, marketing offers for the net online page impression are pre-selected, for example, merchandise and service offers billable to the user's financial account. Additional selection requirements are optionally used based on registration information. For instance, certain offers may be targeted by age, state, gender, etc. The pre-selected marking offers are then displayed to the user such as by Web page popups or in-line pages. The user-selected data corresponding to the offers is received, namely, data is transferred over the Internet from the user's browser to company servers. The user-selected offer data is validated and stored, selected offers being written to a company database server. This triggers real-time or batch processing of the financial transaction using the user's stored financial account information. Both affirmative and negative responses are recorded for future targeting.

Next, orders for goods and/or services placed by the user are fulfilled. Upon successful completion of financial charge, the goods and/or services purchased by the user are delivered to the user. Pre-selected marketing offers continue to be displayed until the user exits the company's online p properties. It is considered desirable that the users be able to remain active on the company's online properties, such as lottery or dating sites, and continue to see specially targeted marketing offers. Moreover, upon the user's return to the online properties, he or she will be shown similarly targeted, pre-selected marketing offers based on information submitted via the ENTRY PORTAL and in the electronic registration forms.

Overall, present invention advantageously provides an automated sweepstakes entry system for dynamically targeting selected entrants for receipt of selected marketing data in exchange for providing selected personal information over an interactive communications network. In this manner, a database is compiled that contains each entrant's biographical information, information sufficient to electronically deposit winnings in at least one of the user's credit card, checking and/or debit card account, and generated data derived from the user's biographical information, account information and the user's activities in response to banner offers, popup offers, or other dynamically served offers presented to the entrant during operation of the system over an interactive communications network. This enables any participating business to consistently and effectively solicit selected personal information from a user and, based upon the information obtained, allow the business to generate a user profile based on geographic, demographic and/or psychographic parameters for targeting the user for future on-line advertising or the like.

Another benefit of the present invention is that it provides a program controlled apparatus, system and method for collecting detailed information about customers, in general, so that a detailed customer profile can be created. This is accomplished using the aforementioned novel method of obtaining customer information by soliciting personal information from customers through gaming and prize reward systems. As a result, not only is the speed and quality of data transfer between merchants, customers and their financial institutions improved, but also the need for many businesses to obtain information about their customers and compile customer profiles is achieved simply, efficiently and economically.

Furthermore, by the present invention, automation of customer data collection and the compiling of customer profiles is maximized, thereby, achieving greater efficiency and cost savings without sacrificing accuracy of the data or profiles compiled, and with minimal human intervention. At the same time, the present invention overcomes the reluctance of many users to provide personal information over the Internet, e.g., by transferring actual or virtual money winnings into the user's financial account, while providing on-line businesses with the information needed to target appropriate customers for information and assemble user profiles based upon the same. Moreover, personal information may now be readily solicited from prospective customers by rewarding them with prize winnings, rather than creating unrealistic expectations of prize winnings as do most conventional gaming, sweepstakes and other prize reward systems. A system and method of this general description is set forth in a U.S. Provisional Patent Application Ser. No. 60/456,132, filed Mar. 19, 2003, entitled as above, the disclosure of which is hereby incorporated by reference herein in its entirety.

Various modifications and alterations to the present invention may be appreciated based on a review of this disclosure. These changes and additions are intended to be within the scope and spirit of this invention as defined by the following claims.

1. A sweepstakes entry system for soliciting and capturing selected personal data from a user over an interactive communications network and, based on the personal data retrieved, dynamically selecting and transmitting selected graphics based applets to the user, the system comprising:
a first server having first programming for generating solicitation data and transmitting the data to a user, second programming for determining whether the user is to receive sweepstakes winnings, and third programming for electronically depositing money corresponding to the sweepstakes winnings in a financial account of the user;
a first program controlled apparatus having programming for receiving the solicitation data from the first server, displaying the data to the user in a selected data format, receiving personal data input by the user, and transmitting the personal data to the second server;
a second server having programming for processing selected personal data received from the user in response to the solicitation data and transmitting discrete content data targeted to the user based on the personal data received;
a first database for storing the personal data input by the user pursuant to the solicitation data displayed; and
an interactive communications network for facilitating the transfer of data between the first program controlled apparatus and the first and second servers;
at least one of the first and second servers housing a virtual portal for receiving the personal data and for transmitting the solicitation and discrete content data to the user over the interactive communications network.

2. The system set forth in claim 1 wherein at least one of the first and second servers has programming for capturing biographical information input by the user.

3. The system set forth in claim 1 wherein at least one of the first and second servers has programming for capturing geographic information input by the user.

4. The system set forth in claim 1 wherein at least one of the first and second servers has programming for capturing psychographic information input by the user.

5. The system set forth in claim 1 wherein at least one of the first and second servers has programming for electronically capturing the user's choice of mode of payment for collecting sweepstakes winnings.

6. The system set forth in claim 1 wherein the discrete content data includes at least one banner type advertising display based upon the personal information.

7. The system set forth in claim 1 wherein the discrete content data includes at least one popup type advertising display based upon the personal information.

8. The system set forth in claim 1 wherein the discrete content data includes at least one dynamically served offer type advertising display based upon the personal information.

9. The system set forth in claim 1 wherein at least one of the servers has programming for generating the discrete content data comprising at least one offer type advertising display to be dynamically served upon the user, the programming having at least one function for identifying and generating marketing opportunities, based upon the personal information and selected data generated by the programming for identifying and generating marketing opportunities.

10. A method of sweepstakes entry that dynamically targets selected users for receipt of selected marketing data over an interactive communications network, the method comprising the steps of:
i. displaying a virtual process entry portal to the user for capturing selected personal data about the user;
ii. receiving the requested personal data from the user;
iii. validating and storing the user provided personal data;
iv. pre-selecting marketing offers based on the user provided personal data;
v. displaying the pre-selected marketing offers to the user;
vi. receiving data selected by the user corresponding to at least one of the pre-selected marketing offers displayed;
vii. validating and storing the data selected by the user;
viii. determining whether the data selected by the user matches data in a winning data set; and
ix. if the data selected by the user matches data in the winning data set, notifying the user of the data match.

11. The method set forth in claim 10 wherein the step of receiving the requested personal information includes capturing the user's choice of mode of payment for collecting sweepstakes winnings.

12. The method set forth in claim 10 wherein the pre-selected marketing offers dis-played to the user include at least one banner type advertising display.

13. The method set forth in claim 10 wherein the pre-selected marketing offers displayed to the user include at least one popup type advertising display.

14. The method set forth in claim 10 wherein the pre-selected marketing offers displayed to the user include at least one dynamically served offer type advertising display.

15. The method set forth in claim 10 wherein the step of pre-selecting marketing offers based upon the user provided personal information includes the steps of identifying and generating marketing opportunities based upon the personal information and selected data generated by the programming for identifying and generating marketing opportunities.

16. A method of sweepstakes entry that solicits and captures selected personal information from a user over an interactive communications network and dynamically selects and transmits a graphics based routine to the user based on the personal information, the method comprising the steps of:
i. viewing a process entry page of a virtual portal displayed by the system for capturing selected personal data about the user;
ii. inputting the personal data requested on the entry page;
iii. viewing marketing offers pre-selected by the system based on the personal data input;
iv. selecting data corresponding to at least one of the pre-selected marketing offers displayed; and
v. if the data selected by the user matches data in a winning data set, viewing winning notification data indicating the data match.

17. A method of entering a sweepstakes that solicits and captures selected personal information from a user over an interactive communications network and dynamically selects and transmits a graphics based routine to the user based on the personal information, the method comprising the steps of:
i. displaying a virtual process entry portal to the user for capturing a data set including at least one of selected biographic, geographic and/or psychographic data about the user;
ii. receiving the requested information from the user;
iii. validating and storing the user provided information;
iv. pre-selecting marketing offers based on the user provided information;
v. displaying the pre-selected marketing offers to the user;
vi. receiving information selected by the user corresponding to at least one of the pre-selected marketing offers displayed;
vii. validating and storing the information selected by the user;
viii. determining whether the information selected by the user matches information in a winning information set; and
ix. if the information selected by the user matches information in the winning information set, notifying the user of the information match.

18. The method set forth in claim 17 wherein the step of receiving the requested personal information includes capturing the user's choice of mode of payment for collecting sweepstakes winnings.

19. The method set forth in claim 17 wherein the pre-selected marketing offers displayed to the user include at least one banner type advertising display.

20. The method set forth in claim 17 wherein the pre-selected marketing offers displayed to the user include at least one popup type advertising display.

21. The method set forth in claim 17 wherein the pre-selected marketing offers displayed to the user include at least one dynamically served offer type advertising display.

22. The method set forth in claim 17 wherein the step of pre-selecting marketing offers based upon the user provided personal information includes the steps of identifying and generating marketing opportunities based upon the personal information and selected data generated by the programming for identifying and generating marketing opportunities.

23. A method of sweepstakes entry that solicits and captures selected personal information from a user over an interactive communications network, and dynamically selects and transmits a graphics based routine to the user based on the personal information, the method comprising the steps of:
i. viewing a process entry page of a virtual portal displayed by a system for capturing a data set including at least one of selected biographic, geographic and/or psychographic data about the user;
ii. inputting the information requested on the entry page;
iii. viewing marketing offers pre-selected by the system based on the information input;
iv. selecting information corresponding to at least one of the pre-selected marketing offers displayed; and
v. if the information selected by the user matches information in a winning information set, viewing winning notification information indicating the information match.

24. A program controlled sweepstakes entry apparatus is provided for soliciting and capturing selected personal information from a user over an interactive communications network and, based on the personal information, dynamically selecting and transmitting at least one graphics based routine to the user, the apparatus having programming for performing at least ten discrete functions including:
a first function for detecting user interaction;
a second function for generating a virtual portal and soliciting selected personal information from the user;
a third function for receiving the selected personal information in response to the second function;
a fourth function for determining selected marketing content to be displayed to the user based upon the personal information input;
a fifth function for accessing at least one data page in accordance with the content determined;
a sixth function for transmitting the selected data page to the user over the network, a seventh function for displaying to the user the data page transmitted;
an eighth function for determining whether the user's personal information qualifies him or her as a winner;
a ninth function for transmitting winning notification data to the user; and
a tenth function for displaying the winning notification data to the user.

25. The system set forth in claim 24 wherein the fourth function identifies and generates marketing opportunities based upon the personal information and selected data generated by the programming for identifying and generating marketing opportunities

26. A hard drive of a program controlled apparatus housing a virtual portal for sweepstakes entry that solicits and captures selected personal information from a user over an interactive communications network and, based on the personal information, dynamically selects and transmits at least one graphics based routine to the user, the hard drive housing programming for performing at least ten discrete functions including:
a first function for detecting user interaction;
a second function for generating a virtual portal and soliciting selected personal information from the user;
a third function for receiving the selected personal information in response to the second function;
a fourth function for determining selected marketing content to be displayed to the user based upon the personal information input;
a fifth function for accessing at least one data page in accordance with the content determined;
a sixth function for transmitting the selected data page to the user over the network;
a seventh function for displaying to the user the data page transmitted;
an eighth function for determining whether the user's personal information qualifies him or her as a winner;
a ninth function for transmitting winning notification data to the user; and
a tenth function for displaying the winning notification data to the user.

27. The system set forth in claim 26 wherein the fourth function identifies and generates marketing opportunities based upon the personal information and selected data generated by the programming for identifying and generating marketing opportunities

28. A plurality of carrier wave signals transmitted over an interactive communications network of a sweepstakes entry system that operates to solicit and capture selected personal information from a user over an interactive communications network and, based on the personal information, dynamically select and transmit at least one graphics based routine to the user, the signals housing at least ten discrete functions including a first operation for detecting user interaction, a second operation for generating a virtual portal and soliciting selected personal information from the user, a third operation for receiving the selected personal information in response to the second operation, a fourth operation for determining selected marketing content to be displayed to the user based upon the personal information input, a fifth operation for accessing at least one data page in accordance with the content determined, a sixth operation for transmitting the selected data page to the user over the network, a seventh operation for displaying to the user the data page transmitted, an eighth operation for determining whether the user's personal information qualifies him or her as a winner, a ninth operation for transmitting winning notification data to the user, and a tenth operation for displaying the winning notification data to the user.

29. The system set forth in claim 28 wherein the fourth function identifies and generates marketing opportunities based upon the personal information and selected data generated by the programming for identifying and generating marketing opportunities.

30. A hard drive of a program controlled apparatus, the hard drive housing a virtual portal for sweepstakes entry that solicits and captures selected personal information from a user over an interactive communications network and, based on the personal information, dynamically selects and transmits at least one graphics based routine to the user, the hard drive housing programming for performing a method comprising the steps of:
i. capturing biographical information provided by the user, the biographical information including at least one data set corresponding to the user's name, postal address, telephone number, birth date and e-mail address;
ii. capturing financial account information provided by the user that is necessary for electronically collecting and depositing money winnings of the user in a corresponding financial account;
iii. validating the biographical information and account information provided by the user;
iv. storing securely the captured biographical information and account information provided by the user on the hard drive;
v. based on the biographical information and account information, dynamically selecting and transmitting to the user at least one graphics based routine containing targeted banner offers, popup offers, or other dynamically served offers;
vi. selecting a sweepstakes entry number corresponding to the user in exchange for providing his or her biographical and account information;
vii. generating data derived from the user's biographical information, account information and the user's activities in response to the banner offers, popup offers, or other dynamically served offers;
viii. storing securely the generated data derived from the user's biographical information, account information and the user's activities;
ix. performing a winning check operation to determine whether the user is a sweepstakes winner by generating and selecting, for the account selected and at preset intervals, a winning number, conducting a winning number generation and selection integrity operation, comparing the sweepstakes entry number issued to the user to the winning number generated and selected, and if the sweepstakes entry number matches the winning number generated, then notifying the user that he or she is a sweepstakes winner and electronically depositing a selected quantity of money in the user's credit card, checking, debit card or like account; and
x. collecting and processing the biographical information, account information, generated data derived, sweepstakes entry number, winning number and all other information relating thereto and storing such information on the hard drive for current and future use.

31. The hard drive set forth in claim 30 wherein the pre-selected marketing offers displayed to the user include at least one dynamically served offer type advertising display.

32. The hard drive set forth in claim 30 wherein the step of pre-selecting marketing offers based upon the user provided personal information includes the steps of identifying and generating marketing opportunities based upon the personal information and selected data generated by the programming for identifying and generating marketing opportunities.

33. A hard drive of a program controlled apparatus, the hard drive housing a virtual portal for sweepstakes entry that solicits and captures selected personal information from a user over an interactive communications network and, based on the personal information, dynamically selects and transmits at least one graphics based routine to the user, the hard drive housing programming for performing a method comprising the steps of:
i. determining whether the user is to receive sweepstakes winnings and, if the user is to receive winnings, electronically depositing money corresponding to the sweepstakes winnings in a financial account of the user;
ii. capturing biographical information provided by the user, the biographical information including at least one data set corresponding to the user's name, postal address, telephone number, birth date and e-mail address;
iii. capturing financial account information provided by the user that is necessary for electronically collecting and depositing money winnings of the user in a corresponding financial account;
iv. validating the biographical information and account information provided by the user;
v. storing securely the captured biographical information and account information provided by the user on the hard drive;
vi. based on the biographical information and account information, dynamically selecting and transmitting to the user at least one graphics based routine containing targeted banner offers, popup offers, or other dynamically served offers;
vii. selecting a sweepstakes entry number corresponding to the user in exchange for providing his or her biographical and account information;
viii. generating data derived from the user's biographical information, account information and the user's activities in response to the banner offers, popup offers, or other dynamically served offers; and
ix. storing securely the generated data derived from the user's biographical information, account information and the user's activities.

34. A sweepstakes entry system for dynamically targeting selected entrants for receipt of selected marketing data over an interactive communications network, the system having at least one hard drive for housing a customer database of sweepstakes entrants assembled by operation of the system over the network, the database containing each entrant's biographical information, information sufficient to electronically deposit winnings in at least one of the user's credit card, checking, debit card or like account, and generated data derived from the user's biographical information, account information and the user's activities in response to banner offers, popup offers, or other dynamically served offers presented to the entrant during operation of the system over the network.

35. A method for dynamically generating and serving graphics based advertising offers to a user over an interactive communications network based upon information previously collected from the user through a virtual portal, which comprises the steps of:
i. periodically generating activity pattern data regarding the user from activity history data to represent product preference, payment preference, maximum purchase amount preference or like information;
ii. storing the user activity data in a set of activity history database tables;
iii. defining advertising offers using targeting rules governing appropriateness, frequency and general conditions under which the offers may be presented to the user visiting the virtual portal;
iv. determining which subset and execution sequence of a selected offer's targeting rule are applicable for a given user;
v. executing the applicable rules against the activity history and pattern data resulting in a positive or negative condition for each rule or rule combination; and
vi. using add serving scripts, applying the rules generated and returned so as to determine whether a selected marketing offer is appropriate for the user.

36. A method for dynamically generating and serving graphics based advertising offers to a user over an interactive communications network based upon information previously collected from the user through a virtual portal, which comprises the steps of:
i. displaying a registration page to the user a user upon the user's entry to a virtual portal of a lottery Web site;
ii. receiving selected registration information solicited from the user;
iii. validating and storing the registration information in a selected database;
iv. displaying a virtual popup Web page to the user with one or more selected Sweepstakes offers and, more or less concurrently, soliciting financial account information from the user;
v. receiving Sweepstakes and financial account information input by the user;
vi. validating and storing the financial account information in the selected database;
vii. comparing the financial account information to a pre-determined Sweepstakes winning number to determine whether the user is a winner;
viii. if the financial account information matches the winning data set, displaying a Web page popup to the user with notification that funds have been deposited in a financial account of the user;
ix. if the financial account information does not match the winning data match, generating a new winning number according to governing Sweepstakes rules;
x. pre-selecting marketing offers based on user's registration information and/or financial account information;
xi. displaying the pre-selected marketing offers to the user;
xii. receiving user-selected data corresponding to the offers;
xiii. validating and storing the user-selected data in the selected database;
xiv. processing the financial transaction associated with the user-selected data using the user's stored financial account information;
xv. filling orders for goods and/or services placed by the user through the user-selected data;
xvi. upon completion of financial transaction processing, delivering the goods and/or services to the user; and
xvii. displaying one or more additional targeted marketing offers to the user based upon financial account information and registration information input by the user.
